(19) United States
(12) Patent Application Publication
(10) Pub. No.: US 2022/0179950 A1
(43) Pub. Date: Jun. 9, 2022

(54) FINGERPRINTING OF SEMICONDUCTOR DIE ARRANGEMENTS

(71) Applicant: Siemens Aktiengesellschaft, München (DE)

(72) Inventors: Hans Aschauer, München (DE); Rainer Falk, Poing (DE); Christian Peter Feist, München (DE); Steffen Fries, Baldham (DE); Aliza Maftun, München (DE); Hermann Seuschek, München (DE); Thomas Zeschg, München (DE)

(21) Appl. No.: 17/425,808

(22) PCT Filed: Dec. 4, 2019
(86) PCT No.: PCT/EP2019/083622

§ 371 Date: Jul. 26, 2021

(30) Foreign Application Priority Data
Jan. 30, 2019 (EP) 19154376.8

(51) Int. Cl. G06F 21/55

(52) U.S. Cl. CPC G06F 21/55; G06F 2221/034

(57) ABSTRACT

A die arrangement and a method of monitoring the same are provided. The die arrangement includes a plurality of dies and a physical interconnection structure extending between and traversing the plurality of dies. The physical interconnection structure is arranged for imparting unpredictable, yet reproducible properties to a digital signal being carried on the physical interconnection structure. The die arrangement further includes a monitoring logic for monitoring the properties of the digital signal. This enables detection of tampering of topological arrangements of semiconductor dies to one another.

The present patent document is a § 371 nationalization of PCT Application Serial No. PCT/EP2019/083622, filed Dec. 4, 2019, designating the United States, which is hereby incorporated by reference, and this patent document also claims the benefit of European Patent Application No. 19154376.8, filed Jan. 30, 2019, which is also hereby incorporated by reference.

### TECHNICAL FIELD

Various embodiments of the disclosure relate to semiconductor die arrangements and methods of monitoring the same. Various embodiments relate in particular to such die arrangements and corresponding methods of monitoring which enable detection of tampering of a topological arrangement of a plurality of semiconductor dies to one another.

### BACKGROUND

In industrial environments, embedded devices like control units, industrial PCs, Internet of Things (IoT), and edge devices assume important tasks such as, for instance, controlling or monitoring of technical processes, and in doing so may carry out critical functions, in particular, with reference to data and information security.

In addition, the devices are increasingly being networked, e.g., for remote control, or for diagnosis and analysis as a basis for subsequent optimization of a process. In industrial systems, field use of embedded devices may extend over long periods, (for example, 10-20 years or sometimes even 30 or 40 years), during which periods the devices are exposed to ever changing circumstances and potential security attacks.

Special passive and invasive attacks, such as side-channel attacks/probing, fault injection, depackaging, and delayering of integrated circuits, on the hardware of such devices may result in security-critical functions and data being compromised.

Counteractive measures for detection and prevention of such attacks like, for instance, drilling protection (e.g., wire meshes), overmolding of dies/packages using epoxy resin, use of security fuses, use of tamper sensors (e.g., detecting security-critical changes in temperature, voltage levels, clock signal properties, light, and/or radiation), monitoring of a current consumption or electromagnetic emission, or use of physical unclonable functions, PUF, e.g., protect individual integrated circuits or dies only.

### BRIEF SUMMARY

In view of the above, there is a need in the art for detection of tampering of a topological arrangement of semiconductor dies to one another. This equally relates to die arrangements within a same integrated circuit (IC) package, e.g., multi-chip modules (MCM) or system-in-package (SiP) to discrete die arrangements on printed circuit boards (PCB) or to combinations thereof.

These underlying objects are solved by a die arrangement and a method of monitoring the same as disclosed herein. The scope of the present disclosure is defined solely by the appended claims and is not affected to any degree by the statements within this summary. The present embodiments may obviate one or more of the drawbacks or limitations in the related art.

According to a first aspect, a die arrangement is provided. The die arrangement includes a plurality of dies; a physical interconnection structure extending between and traversing the plurality of dies, and being arranged for imparting unpredictable, yet reproducible properties to a digital signal being carried on the physical interconnection structure; and a monitoring logic for monitoring the properties of the digital signal.

The physical interconnection structure may include an electrically conducting structure.

The monitoring logic may be arranged for monitoring the properties of the digital signal against characteristic reference data of the digital signal.

The monitoring logic may be arranged for monitoring semantic properties of the digital signal.

The monitoring logic may be arranged for monitoring an eye opening of the digital signal.

The physical interconnection structure may form a ring oscillator (RO) structure. Additionally, the monitoring logic may be arranged for monitoring an oscillation frequency of the digital signal.

The characteristic reference data may be machine-learned.

The characteristic reference data may be determined using hard-coded rules.

The characteristic reference data may be determined while reducing time-varying environmental factors.

The monitoring logic may include a storage device for the characteristic reference data.

The storage device may include at least one of a protected memory area and one or more chip fuses.

The monitoring logic may include an internal logic structure of at least one of the plurality of dies.

The monitoring logic may be arranged for generating a tamper event upon a breach of signal integrity.

According to a second aspect, a method of monitoring a die arrangement is provided. The underlying die arrangement includes a plurality of dies and a physical interconnection structure extending between and traversing the plurality of dies. The method includes carrying a digital signal on the physical interconnection structure, wherein the physical interconnection structure is arranged for imparting unpredictable, yet reproducible properties to the digital signal. The method further includes monitoring the properties of the digital signal.

The method may be performed for monitoring the die arrangement of various embodiments.

### BRIEF DESCRIPTION OF THE DRAWINGS

Embodiments of the disclosure will be described with reference to the accompanying drawings, in which the same or similar reference numerals designate the same or similar elements.

FIGS. 1 and 2 illustrate schematic die arrangements according to embodiments.

FIGS. 3 and 4 illustrate topological die arrangements according to embodiments.

FIG. 5 illustrates a method of an embodiment, the method being for monitoring a die arrangement of various embodiments.

### DETAILED DESCRIPTION OF EMBODIMENTS

Exemplary embodiments of the disclosure will now be described with reference to the drawings. While some embodiments will be described in the context of specific fields of application, the embodiments are not limited to this field of application. Further, the features of the various embodiments may be combined with each other unless specifically stated otherwise.

The drawings are to be regarded as being schematic representations and elements illustrated in the drawings are not necessarily shown to scale. Rather, the various elements are represented such that their function and general purpose become apparent to a person skilled in the art.

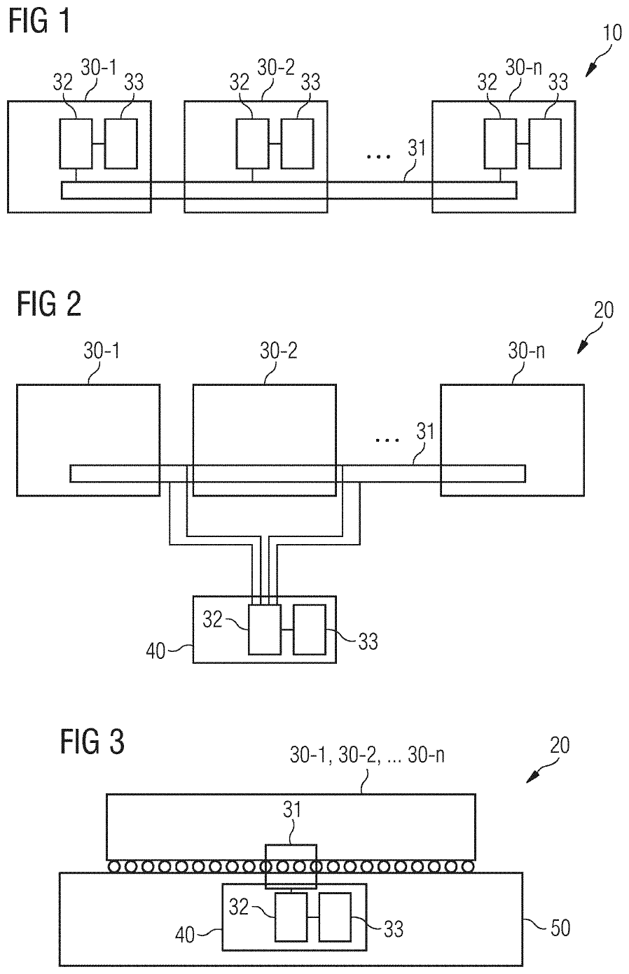

FIGS. 1 and 2 illustrate examples of schematically arranged die arrangements 10, 20 according to embodiments.

The die arrangement 10 of FIG. 1 includes a plurality of dies 30-1, 30-2, 30-n, and a physical interconnection structure 31 extending between and traversing the plurality of dies 30-1, 30-2, 30-n.

A “die” is a section of semiconducting material on which a logic structure/circuit or a mixed-signal structure/circuit or an analog structure/circuit having a particular function has been established.

The physical interconnection structure 31 includes an electrically conducting structure extending between and traversing the plurality of dies 30-1, 30-2, 30-n.

An “electrically conducting structure” as used herein may relate to a waveguide, a wire, a through-silicon via (TSV), and the like, made of metal or metal alloy.

The physical interconnection structure 31 may alternatively or additionally include an optically conducting structure.

An “optically conducting structure” as used herein may relate to a waveguide or fiber made of a material facilitating conductance of light signals.

The physical interconnection structure 31 is arranged for imparting unpredictable, yet reproducible properties to a digital signal being carried on the physical interconnection structure 31.

These properties particularly relate to physical variations occurring naturally during semiconductor manufacture and enabling differentiation between otherwise identical semiconductors. Such random physical factors introduced during manufacturing may, for instance, result in small geometric variations in terms of waveguide lengths, widths, cross-sectional areas, and the like, which in turn result in variations in signal delays, signal attenuation, circuit capacities, and so forth.

The physical interconnection structure 31 may be part of a physical unclonable function (PUF) unit.

A “physical unclonable function” or “PUF” as used herein may relate to a digital/mixed signal circuit element being arranged to impart the above-mentioned unpredictable, yet reproducible properties to a digital signal being carried on a physical interconnection structure, and to amplify such properties.

A “PUF unit” as used herein may relate to a circuit member/structure including a PUF and being arranged for imparting, in response to an input (e.g., challenge) and using the PUF, the above-mentioned unpredictable, yet reproducible properties, to a corresponding output (e.g., response). For instance, a PUF may turn a digital signal (e.g., challenge) into a delayed and/or attenuated digital signal (e.g., response), and a change of round-trip delay or differential propagation delays may be monitored. Examples of PUF units include oscillator PUFs, sum PUFs, and arbiter PUFs. A PUF unit is less susceptible to disturbances than single RO structures, but requires more chip resources.

In the non-limiting example of FIG. 1, the respective die 30-1, 30-2, 30-n includes a monitoring logic 32 for monitoring the above-mentioned properties of the digital signal, in particular, against characteristic reference data of the digital signal. In this embodiment, the respective die 30-1, 30-2, 30-n further includes a storage device 33 for the characteristic reference data. The respective die 30-1, 30-2, 30-n may be provided with a monitoring logic 32 and corresponding storage device 33, as necessary. For instance, this may not be the case if the die has no security-critical function.

“Monitoring against” as used herein may relate to observing and evaluating quantities and/or qualities over a period of time, for instance continuously, with reference to (e.g., against) reference quantities and/or qualities.

“Characteristic reference data” as used herein may relate to data determined in and representing a non-tampered state of the underlying die arrangement 10, 20. Accordingly, monitored properties of the digital signal corresponding to the characteristic reference data indicate that the underlying die arrangement 10, 20 is in a non-tampered state. The characteristic reference data may denote one or more value ranges for particular properties of the digital signal and/or for distinction in terms of criticality of any deviation from the non-tampered state (see below).

Modification of a topology of the die arrangement 10, 20, be it by separating/desoldering individual dies for reverse engineering, by attachment of additional probes, or by modification of temperature, supply voltage, or other global parameters, results in a corresponding modification of the above-mentioned properties of the digital signal being monitored. This entails a possibility of detecting a tampering of the die arrangement 10, 20, in particular by monitoring these properties and comparing them against characteristic reference data of the digital signal. Only few chip resources are needed for tamper detection in the arrangement 10, 20. In addition, the above die arrangement 10, 20 may be combined with known approaches of tamper detection or tamper hardening. The arrangement 10, 20 further complicates tampering or reverse engineering.

The respective monitoring logic 32 may be arranged for monitoring semantic properties of the digital signal. For instance, known communication protocols may be used for semantic monitoring of the digital signal, as these communication protocols define the contents/semantics of the digital signal being carried on the physical interconnection structure 31. For instance, the digital signal may be captured for subsequent monitoring of cyclic signal patterns or values.

The respective monitoring logic 32 may alternatively or additionally be arranged for monitoring statistic properties of the digital signal. The statistic properties may affect timing properties within a time window. For example, the number of changes from low to high and from high to low within a time window may be determined, or the relation between time periods within the time window in which the signal is high and time periods within the time window in which the signal is low. Furthermore, statistical properties between multiple signals may be determined, e.g., a cross-correlation.

The respective monitoring logic 32 may alternatively or additionally be arranged for monitoring an eye opening of the digital signal.

An “eye opening” as used herein may relate to a vertical height, horizontal width and/or a shape/contour of an interior of an eye diagram. An eye diagram is generated by superimposing positive and negative pulses of a sampled digital signal such that the superimposed pulses are horizontally centered between their leading and trailing edges. The resulting diagram resembles an opening of an eye, and a vertical height, a horizontal width as well as a shape/contour of which provide indications of an average instantaneous attenuation and an average instantaneous delay affecting the sampled digital signal, respectively. Upon tampering of the physical interconnection structure 31, (e.g., by moving one of the dies 30-1, 30-2, 30-n further away from the others), variations of the instantaneous attenuation and/or instantaneous delay of the digital signal being carried on the physical interconnection structure 31 may be expected, such that the vertical height and/or horizontal width of the interior of the corresponding eye diagram, or simply the eye opening, is varied.

The physical interconnection structure 31 shown in FIG. 1 forms a ring oscillator (RO) structure. This entails the use of a minimum of chip/interconnection resources. Accordingly, the monitoring logic 32 is arranged for monitoring an oscillation frequency of the digital signal being carried on the physical interconnection structure 31. For instance, the RO structure may include a number of logic gates/circuits implementing a feedback loop having a round-trip delay. An oscillation frequency of a digital signal being carried on such a structure depends on the above-mentioned random physical factors introduced during manufacturing. The RO-structure may be self-oscillating, or merely be excited on demand, which entails power energy savings. Alternatively to a RO structure, also linear structures on which oscillations or delays may set in are conceivable.

The characteristic reference data may be machine-learned. For instance, an artificial neural network and known methods of training the same may be used to realize machine learning of the characteristic reference data. This entails a monitoring against automatically learned characteristic reference data without requiring an explicit instance thereof, so that even complex nonlinear properties of the digital data may be monitored and mapped to a non-tampered state or any different state.

In such case, the monitoring logic 32 may include a tensor processing unit (TPU) for monitoring and evaluating the properties of the digital signal against the machine-learned characteristic reference data. This entails a highly accelerated execution of the machine-learning-based monitoring.

A “tensor processing unit” or “TPU” is an application-specific integrated circuit (ASIC) developed specifically for accelerating neural network machine learning.

Alternatively, or additionally, the characteristic reference data may be determined using hard-coded rules. For instance, heuristics may be used to provide the characteristic reference data. This entails a simple and comprehensible way of determining the characteristic reference data.

The characteristic reference data may be determined while reducing time-varying environmental factors. It may particularly be recommendable to eliminate an impact of temperature variations on the die arrangement 10, 20. This entails an improved reliability of the monitoring against the characteristic reference data.

The characteristic reference data may be determined in a provisioning phase during manufacturing of the die arrangement 10, 20. This entails a high amount of flexibility for determining the characteristic reference data.

“Provisioning” as used herein may relate to an act, step, or state of being prepared before active service or field use.

Alternatively, or additionally, the characteristic reference data may be determined in a provisioning phase during commissioning of the die arrangement 10, 20.

“Commissioning” as used herein may relate to an act, step, or state of configuration, after manufacturing and before active service or field use, at the service site, in field, or a comparable environment.

This provides that the provisioning and the active service or field use are based on comparable environmental factors.

Alternatively or additionally, the characteristic reference data may be determined during use of the die arrangement 10, 20, e.g., during the above-mentioned active service or field use. This entails a capability of the die arrangement 10, 20 of self-calibration or self-recalibration upon variation of the environmental factors or at the request of the device operator.

The storage device 33 of the respective die of the plurality of dies 30-1, 30-2, 30-n includes at least one of a protected memory area and one or more chip fuses. For instance, a protected memory area may include an access-restricted static memory area. A storage device 33 based on one or more chip fuses, which may be put in place for manufacturer configuration of the die, may also be arranged next to the respective die and statically store binary values/digits depending on their presence or absence. For instance, one or more chip fuses may be used to enable and/or address a particular protected memory area, or permanently store hard-coded characteristic reference data.

In FIG. 1, the monitoring logic 32 of the respective die of the plurality of dies 30-1, 30-2, 30-n includes an internal logic structure of the respective die. This entails that a new die arrangement 20 may be tamper-hardened using the built-in monitoring logic 32.

By contrast, in the die arrangement 20 illustrated in FIG. 2, an external/separate security IC 40 includes the monitoring logic 32 in combination with a corresponding storage device 33 for the characteristic reference data. This entails that an existing die arrangement 20 may be tamper-hardened using external monitoring logic 32 as implied by the separate security IC 40 in FIG. 2. An external monitoring logic 32 is connected to the physical interconnection structure 31 at interfaces between the plurality of dies 30-1, 30-2, 30-n, see FIG. 2.

In any case, the monitoring logic 32 is arranged for generating a tamper event upon a detected breach of signal integrity.

A “tamper event” as used herein may relate to any kind of communication or notification that the properties of the digital signal as monitored by the monitoring logic 32 are not in conformity with the characteristic reference data of the digital signal as stored by its corresponding storage device 33, where non-conformity denotes a breach of signal integrity.

Depending on a type of the physical interconnection structure 31, a breach of signal integrity may, for instance, result from non-conformity of a monitored oscillation frequency, of a monitored eye opening (or corresponding eye-opening penalty), or of a monitored PUF-response (e.g., an excessive Hamming distance), and the like.

For instance, a tamper event may include setting at least one bit in a particular hardware register or memory location to a defined value, triggering interrupt handling by a processor, or setting an external signal to a defined value, such that a response to such a tamper event may be handled or triggered by another logic member. For instance, a cryptographic key store may lock access to or delete a stored security key in response to the detection of a tamper event generated by the monitoring logic 32, or security-critical logic functions may be deactivated.

The monitoring logic 32 may be arranged for logging and/or classifying the tamper event, in particular if the tamper event is passed on to a higher software layer. For instance, depending on a location of tampering, or on a type and/or extent of distortion of an eye diagram, or on an extent of detuning of a RO structure, a tamper event may be classified in terms of its location (e.g., “between dies 1 and 2”) and/or criticality. This entails a response at a scale being adequate for and in conformity with the assigned class. The classification may be encoded in the tamper event. This allows classifying the tamper event at a higher level (e.g., in software).

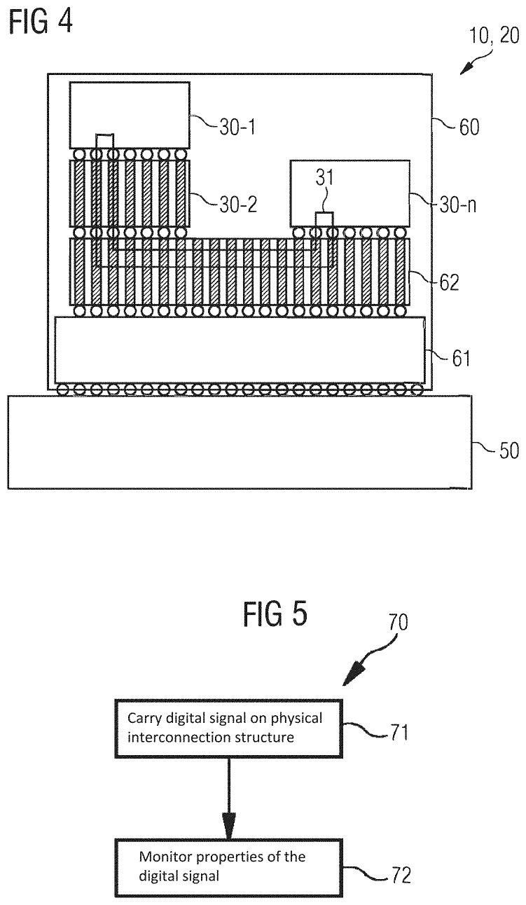

FIGS. 3 and 4 illustrate examples of topologically arranged die arrangements 10, 20 according to embodiments.

The die arrangement 20 of FIG. 3 includes a system-on-chip (SoC), e.g., a monolithic-integrated arrangement of the plurality of dies 30-1, 30-2, 30-n in a common package. According to the example of FIG. 3, the SoC is arranged and soldered on a PCB 50 using package bumps.

The die arrangement 20 of FIG. 3 further includes a discretely arranged security IC 40, which may or may not be seen as belonging to the plurality of dies 30-1, 30-2, 30-n, and which is embedded in a PCB 50. The security IC 40 is similar to the one already mentioned in connection with FIG. 2 and may include a cryptographic key store and be used by the SoC as a cryptographic key store module.

If the physical interconnection structure 31 merely extends between and traverses the plurality of dies 30-1, 30-2, 30-n on the SoC, this entails additional tamper protection by monitoring the integrated die arrangement 20 of the SoC.

If the physical interconnection structure 31 extends between and traverses the plurality of dies 30-1, 30-2, 30-n including the security IC 40, as depicted in FIG. 3, then the security IC 40 may be seen as belonging to the plurality of dies 30-1, 30-2, 30-n as already mentioned. This entails additional tamper protection by monitoring the partially integrated die arrangement 20 including the plurality of dies 30-1, 30-2, 30-n of the SoC and of the security IC 40.

The die arrangement 10, 20 of FIG. 4 includes a hybrid-integrated arrangement of the dies 30-1, 30-2, 30-n in a package 60, denoting a system-in-package (SiP) and including a common substrate 61 arranged and soldered on a PCB 50 using package bumps.

Unlike 2D packaging, in which the hybrid-integrated dies 30-1, 30-2, 30-n would be directly connected to the common substrate 61, the die arrangement 20 of FIG. 4 further includes a silicon interposer 62 having through-silicon vias (TSVs), through which the hybrid-integrated die 30-n is connected to the common substrate 61, as in 2.5D packaging. The silicon interposer 62 is arranged and soldered on the common substrate 61 using flip-chip bumps, and the hybrid-integrated die 30-n is arranged and soldered on the silicon interposer 62 using micro bumps.

In the die arrangement 10, 20 of FIG. 4, the hybrid-integrated die 30-2 of the hybrid-integrated dies 30-1, 30-2, 30-n additionally has TSVs on its part, through which the hybrid-integrated die 30-1 is connected to the common substrate 61, as in 3D packaging. The hybrid-integrated dies 30-1, 30-2 are arranged and soldered on the respective underlying TSV-providing component 30-2, 62 using micro bumps.

In the embodiment of FIG. 4, the physical interconnection structure 31 extends between and traverses the plurality of dies 30-1, 30-2, 30-n as well as the silicon interposer 62 within the 3D package 60.

In FIG. 4, the monitoring logic 32 of the die arrangement 10, 20 is omitted for reasons of improved visibility, but the die arrangement 10, 20 nevertheless includes an internal logic structure as in FIG. 1 and/or a separate logic structure as in FIG. 2 as the monitoring logic 32. This entails additional tamper protection of the integrated die arrangement 10, 20.

In summary, the topological die arrangement 10, 20 may be monitored in any conceivable die arrangement having any conceivable packaging variant.

FIG. 5 illustrates a method 70 of an embodiment, the method 70 being for monitoring a die arrangement 10, 20 of various embodiments.

The die arrangement 10, 20 underlying the method 70 includes a plurality of dies 30-1, 30-2, 30-n and a physical interconnection structure 31 extending between and traversing the plurality of dies 30-1, 30-2, 30-n.

In act 71, a digital signal is carried 71 on the physical interconnection structure 31, during which the physical interconnection structure 31 is arranged for imparting unpredictable, yet reproducible properties to the digital signal.

In act 72, the properties of the digital signal are monitored 72.

The method 70 may be performed for monitoring the die arrangement 10, 20 of various embodiments.

The technical effects and advantages described above in relation with the die arrangement of various embodiments equally apply to the corresponding method for monitoring the die arrangement having corresponding features.

While die arrangements and methods of monitoring the same of various embodiments have been described, those skilled in the art will appreciate that the present disclosure is not so limited and that the present disclosure may be carried out in other ways than those specifically set forth herein without departing from characteristics of the disclosure. The present embodiments are therefore to be considered in all respects as illustrative and not restrictive, and all changes coming within the meaning and equivalency range of the appended claims are intended to be embraced therein.

It is to be understood that the elements and features recited in the appended claims may be combined in different ways to produce new claims that likewise fall within the scope of the present disclosure. Thus, whereas the dependent claims appended below depend from only a single independent or dependent claim, it is to be understood that these dependent claims may, alternatively, be made to depend in the alternative from any preceding or following claim, whether independent or dependent, and that such new combinations are to be understood as forming a part of the present specification.

1. A die arrangement, comprising:
a plurality of dies;
a physical interconnection structure extending between and traversing the plurality of dies, and being configured to impart unpredictable, yet reproducible properties to a digital signal being carried on the physical interconnection structure; and
a monitoring logic configured to monitor the properties of the digital signal.

2. The die arrangement of claim 1, wherein the physical interconnection structure comprises an electrically conducting structure.

3. The die arrangement of claim 1, wherein the monitoring logic is configured to monitor the properties of the digital signal against characteristic reference data of the digital signal.

4. The die arrangement of claim 3, wherein the monitoring logic is configured to monitor semantics properties of the digital signal.

5. The die arrangement of claim 3, wherein the monitoring logic is configured to monitor an eye opening of the digital signal.

6. The die arrangement of claim 1, wherein the physical interconnection structure forms a ring oscillator structure, and
wherein the monitoring logic is configured to monitor an oscillation frequency of the digital signal.

7. The die arrangement of claim 3, wherein the characteristic reference data is machine-learned.

8. The die arrangement of claim 3, wherein the characteristic reference data is determined using hard-coded rules.

9. The die arrangement of claim 3, wherein the characteristic reference data is determined while reducing time-varying environmental factors.

10. The die arrangement of claim 3, wherein the monitoring logic comprises a storage device for the characteristic reference data.

11. The die arrangement of claim 10, wherein the storage device comprises at least one of a protected memory area and one or more chip fuses.

12. The die arrangement of claim 1, wherein the monitoring logic comprises an internal logic structure of at least one of the plurality of dies.

13. The die arrangement of claim 1, wherein the monitoring logic is configured to generate a tamper event upon a breach of signal integrity.

14. A method of monitoring a die arrangement comprising a plurality of dies and a physical interconnection structure extending between and traversing the plurality of dies, the method comprising:
carrying a digital signal on the physical interconnection structure of the die arrangement, wherein the physical interconnection structure imparts unpredictable, yet reproducible properties to the digital signal; and
monitoring the properties of the digital signal.

15. The method of claim 14, wherein the die arrangement further comprises a monitoring logic, and
wherein the monitoring logic monitors the properties of the digital signal.

16. The die arrangement of claim 2, wherein the monitoring logic is configured to monitor the properties of the digital signal against characteristic reference data of the digital signal.

17. The die arrangement of claim 16, wherein the monitoring logic is further configured to monitor semantics properties of the digital signal.

18. The die arrangement of claim 17, wherein the monitoring logic is further configured to monitor an eye opening of the digital signal.

19. The die arrangement of claim 18, wherein the physical interconnection structure forms a ring oscillator structure, and
wherein the monitoring logic is further configured to monitor an oscillation frequency of the digital signal.
